(19) United States
(12) Patent Application Publication
(10) Pub. No.: US 2015/0173520 A1
(43) Pub. Date: Jun. 25, 2015

(54) Furniture Unit with Moisture Barrier and Method

(71) Applicant: Blockhouse Company, Inc., York, PA (US)

(72) Inventor: Richard Anthony Moul, Lewisberry, PA (US)

(73) Assignee: BLOCKHOUSE COMPANY, INC., York, PA (US)

(21) Appl. No.: 14/569,839

(22) Filed: Dec. 15, 2014

Related U.S. Application Data
(60) Provisional application No. 61/918,697, filed on Dec. 20, 2013.

(51) Int. Cl. A47C 19/02; A47C 31/00; B05D 1/02; B27N 7/00

(52) U.S. Cl. CPC A47C 19/025; B27N 7/005; A47C 31/00; B05D 1/02

(57) ABSTRACT

A furniture unit including a barrier layer substantially impervious to fluids, moisture, odors, and other undesirable substances is provided, as well as a method of making a surface of the furniture unit impervious to such fluids and other undesirable substances.

### CROSS REFERENCE TO RELATED APPLICATION AND CLAIM TO PRIORITY

This application is based on U.S. provisional application Ser. No. 61/918,697, filed Dec. 20, 2013, which application is incorporated herein by reference in its entirety and to which priority is claimed.

### FIELD OF THE INVENTION

The present invention relates to a furniture unit including a barrier to fluids, odors, and other undesirable substances, and a method of making a surface of the furniture unit impervious to fluids and other undesirable substances.

### BACKGROUND OF THE INVENTION

Beds and other furniture units are often exposed to a variety of substances that may cause damage to the unit, cause malodors, and/or present a health or safety hazard. Indeed, furniture units in hospitals, child care facilities, elder care facilities, schools, military facilities, correctional facilities, etc. are routinely exposed to bodily fluids (e.g., blood, urine, menses, tears, sweat, other discharge, etc.) and other substances (food, cleaners, oils, greases, ink, bacteria, fungi, etc.). Beds are particularly susceptible to degradation from fluids and other substances, which may soak into the support surface and/or frame as an occupant thereon is resting or restrained.

As such, there have been various attempts to provide furniture units with a moisture and/or odor barrier, particularly furniture units constructed from wood, wood composites or other materials pervious to fluids, odors, fungi, bacteria, or other harmful substances. Paints or stains may be applied to the furniture unit, which somewhat reduce the permeability of the unit surface to fluids and other substances. However, paints and stains alone do not provide a sufficiently impervious barrier for many applications. Moreover, such coatings may be easily scratched, chipped or otherwise damaged, thereby degrading the ability of the coating to resist further damage.

As such, secondary barriers are often utilized in conjunction with furniture units such as beds requiring more robust protection against fluids and other damaging substances. For example, polymer sheets or absorbent liners may be placed under the bedding material or mattress. Alternatively or in addition, the bedding material or mattress may include a flexible polymer sheet or covering. Unfortunately, such secondary barriers often fail to adequately shield the underlying support surface or frame of the furniture unit from the deleterious substances, particularly fluids which seep around the bedding and mattress and into the permeable surface of the furniture unit.

Alternatively, furniture units formed from metal or polymer materials have been provided, which are relatively impervious to some liquids. Metal furniture units may additionally be coated with a polymer coating, such as a thermoplastic powder coating. While such metal or polymer furniture units are somewhat impervious to fluids, the metal and polymer components are susceptible to rust and damage from harsh chemicals, ultraviolet light, and temperature fluctuations. Moreover, such metal and polymer furniture units are not aesthetically appealing to many consumers.

Therefore, there is a need for a furniture unit having a barrier layer that is substantially impervious to fluids, odors and other undesirable or harmful substances, and that solves some or all of the above-noted problems.

### SUMMARY OF THE INVENTION

The present invention is directed to a furniture unit including a barrier that is substantially impervious to fluids, moisture, odors, bacteria, fungus and other deleterious substances. In one embodiment, the furniture unit is a bed including a support surface lined or coated with a polyurea material which forms a barrier layer impervious to fluids and incidental moisture (e.g., such as urine or feces from incontinence, blood, menses, sweat, tears, etc.). The barrier layer prevents such fluids from soaking into the underlying wood or wood composite components of the furniture unit, thereby preventing or substantially minimizing bacterial growth and malodors. The barrier layer is also substantially impervious to other substances such as food, harsh chemical cleaners, oils, greases, etc. The barrier layer additionally helps to protect the coated furniture components from damage from fungus and insects.

The barrier layer forms a durable surface that may be readily cleaned using relatively harsh cleaning agents otherwise unusable for cleaning and/or sterilizing wood or wood composite materials.

In addition, the barrier layer provides a substantially smooth, seamless surface on the furniture unit, filling and eliminating any cracks, gouges, or other recesses that may otherwise be present in the furniture surface. The elimination of any such cracks or other recesses provides an aesthetically appealing surface, and also prevents persons using the furniture from hiding or otherwise storing any items in such cracks or recesses. Thus, a bed including the disclosed barrier layer on the bed deck surface thereof is particularly suitable for applications such as correctional facilities or hospitals, where the inmate or patient may otherwise seek to hide contraband in the bed deck surface. In addition, the barrier layer is applied using a method that creates a seamless edge that is “pick-proof,” which prevents or minimizes the possibility of a user from mutilating or otherwise harming the coated surface. In addition, the barrier layer prevents or minimizes the possibility of the user from prying a shard or sharp piece of veneer, plywood, etc. from the bed (or other furniture piece), and using such shard to harm themselves or others.

According to embodiments of the present invention, a furniture unit is provided comprising a support member having a central portion, an edge portion surrounding the central portion, and an interface portion intermediate and interconnecting the central portion and the edge portion. A barrier layer impervious to fluids and other undesirable substances coats the central portion and the interface portion. Preferably, the barrier layer is impervious to fungus and insects. The barrier layer has a first caliper of at least about 20 mils (0.02 inch) coating the central portion, and a second caliper tapered from at least about 20 mils adjacent to the first caliper to less than about 1 mil (0.001 inch) adjacent to the edge portion.

In preferred embodiments, the barrier layer comprises a polyurea material. The support member may be formed from a solid wood, a wood composite material, or an engineered wood material. In some implementations, the first caliper is between about 20 mils and about 250 mils. In some implementations, the barrier layer has a Shore Hardness D value of at least about 50 and/or a flexural strength value of at least about 1000 psi.

According to other embodiments, a furniture unit comprises a planar support panel having a generally rectangular configuration including a central portion, and opposing side portions and opposing end portions surrounding the central portion. Opposing side panels are connected to and extend upwardly from the opposing side portions, respectively. Opposing end panels are connected to and extend upwardly from the opposing end portions, respectively. The planar support panel and the opposing side and end panels define a recessed area. A barrier layer impervious to fluid coats the recessed area. The barrier layer has a first caliper adjacent to the central portion and a second caliper adjacent to distal edges of the opposing side and end panels. The first caliper is at least 10 times greater than the second caliper, and in some implementations at least about 20 times greater than the second caliper.

In preferred embodiments, the barrier layer comprises a polyurea material. In some implementations, the first caliper is at least about 20 mils and/or the second caliper is less than about 1 mil. In some embodiments, the barrier layer has a tapered third caliper from the first caliper to the second caliper. In some embodiments, the furniture unit is a bed, and the recessed area is configured to receive bedding material. In some embodiments, the furniture unit also includes a sealant bead disposed along and covering interfaces between the opposing side panels and the opposing side portions, and covering interfaces between the opposing end panels and the opposing end portions, wherein the barrier layer covers the sealant bead.

According to disclosed embodiments, a method of manufacturing a furniture unit having a support member impervious to fluids comprises the steps of: providing a furniture unit comprising a planar support portion; applying via a spray device having a spray nozzle at least first and second swaths of polyurea material onto the planar support portion, the first and second swaths forming a first coat of polyurea material having a caliper of at least about 20 mils and a raised seam intermediate the first and second swaths, wherein the planar support portion is spaced a first distance from the spray nozzle when applying the first and second swaths; and applying via the spray device at least a third swath of polyurea material onto the first and second swaths and covering the raised seam, the third swath forming a second coat of polyurea material having a caliper of about 2 mils or less, wherein the planar support portion is spaced a second distance from the spray nozzle when applying the third swath, the second distance at least about twice the first distance. In some embodiments, the first distance is about 15 inches or less. In some embodiments, the second distance is at least about 20 inches. Preferably, the second coat has a caliper of less than about 1 mil.

### BRIEF DESCRIPTION OF THE DRAWINGS

FIG. 1 is a perspective view of a bed including a barrier layer according to an embodiment of the present invention.

FIG. 2 is a cross-sectional view of the bed of FIG. 1 taken along line 2-2.

FIG. 3 is an exploded cross-sectional view of the circled portion in FIG. 1.

FIG. 4 is an exploded view of the circled portion of FIG. 2.

### DETAILED DESCRIPTION OF EMBODIMENTS OF THE INVENTION

The terms “left,” “right,” “top,” “bottom,” “front,” “rear,” “side,” “height,” “length,” “width,” “upper,” “lower,” “interior,” “exterior,” “inner,” “outer” and the like, as may be used herein, merely describe points or portions of reference and do not limit the present invention to any particular orientation or configuration. Further, terms such as “first,” “second,” “third,” etc., merely identify one of a number of portions, components and/or points of reference as disclosed herein, and do not limit the present invention to any particular configuration or orientation.

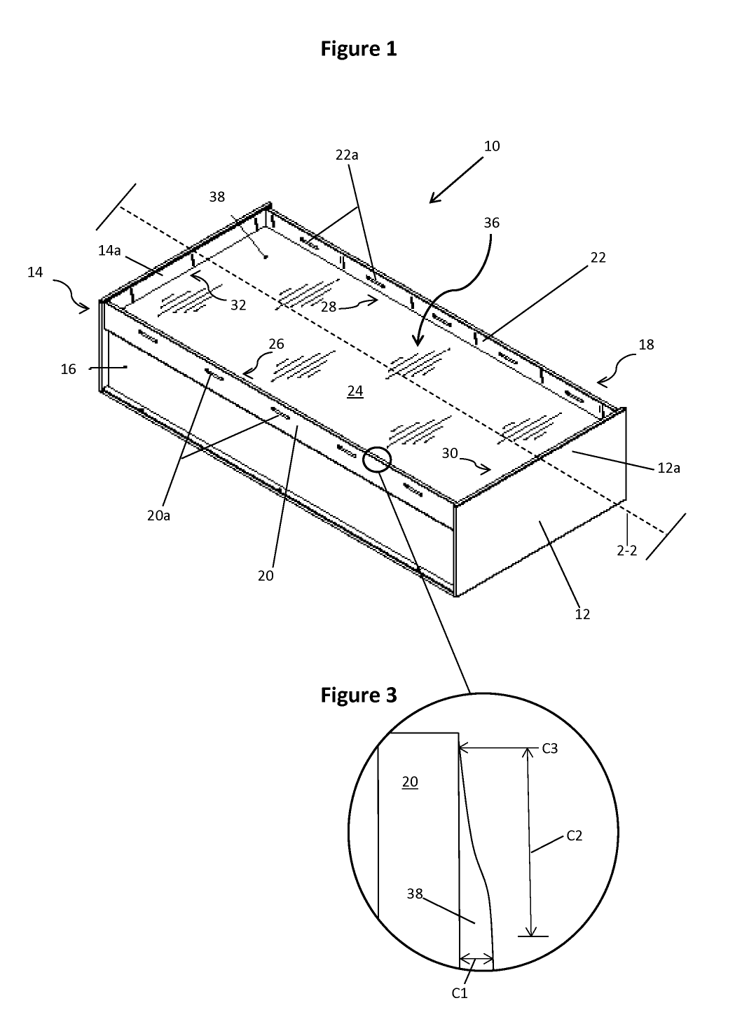

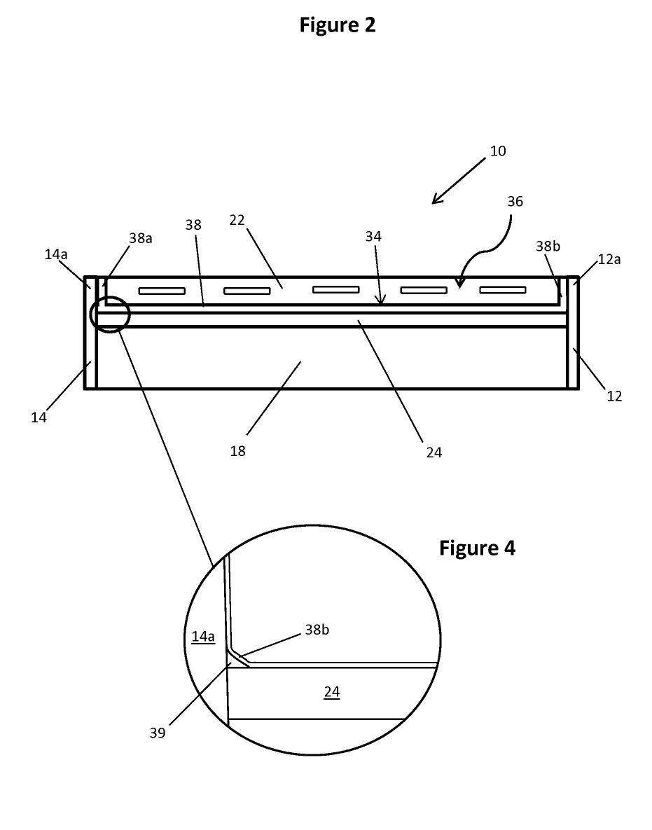

Referring to FIGS. 1 and 2, a bed unit 10 according to an embodiment of the present invention is illustrated. Bed unit 10 includes opposing end panels 12, 14, opposing side panels 16, 18, and first and second side rail members 20, 22. A planar support panel or deck 24 is disposed between and supported by opposing end panels 12, 14 and side panels 16, 18. In one implementation, end panels 12, 14 and/or side panels 16, 18 are secured to deck 24 via bolts, screws, pins or the like. Bed unit 10 may also include internal support members (not shown) which additionally or alternatively support deck 24 in a fixed position relative to end panels 12, 14 and side panels 16, 18. Further, bed unit 10 may include floor rails (not shown), which accept security hardware for on-site floor attachment, as appropriate for some applications.

Side rail members 20, 22 extend upwardly from and adjacent to opposing side portions or edges 26, 28 of deck 24. Side rails members 20, 22 may include one or more openings or slots 20a, 22a, respectively, or additionally or alternatively handles, anchors, etc. for grasping while moving bed unit 10 and/or for anchoring straps or other tie-downs (e.g., such as to restrain a patient if necessary). In one implementation, the exteriorly disposed surfaces of side rail members are substantially coplanar with the exteriorly disposed surfaces of side panels 16, 18, respectively. Upper portions 12a, 14a of end panels 12, 14 extend upwardly from opposing end portions or edges 30, 32 of deck 24. Thus, an upwardly disposed planar surface 34 of deck 24 is recessed from the top edges of side rail members 20, 22 and upper portions 12a, 14a of end panels 12, 14, forming a recessed area 36. Recessed area 36 is preferably sized and configured to receive bedding material and/or a mattress (not shown), which is retained therein and restricted from sliding on deck 24 by side rail members 20, 22 and upper portions 12a, 14a of end panels 12, 14.

In one embodiment, end panels 12, 14, side panels 16, 18, side rail members 20, 22 and deck 24 are formed from solid wood and/or a wood composite or engineered wood material (e.g., plywood, veneered material, medium density fiberboard, oriented strand board, particleboard, etc.). In other embodiments, some or all of the components may be formed from other materials such as a polymer composition.

With continued reference to FIG. 2, bed unit 10 includes a barrier layer 38 disposed over and substantially covering, and preferably entirely covering, the upwardly disposed planar surface 34 of deck 24. Barrier layer 38 also preferably substantially or entirely covers the inwardly disposed surfaces of upper portions 12a, 14a of end panels 12, 14 (identified by 38a, 38b in FIG. 2), and the inwardly disposed surfaces of side rail members 20, 22. Thus, the recessed area 36 is preferably substantially covered, and more preferably entirely covered, by barrier layer 38. Barrier layer 38 preferably forms an integral, seamless layer or coating covering separate yet attached components of bed unit 10 (e.g., such as components forming recessed area 36).

Barrier layer 38 is preferably impervious to fluids and other undesirable substances, including any moisture, odors, bacteria, fungus and other deleterious substances. Barrier layer 38 is thus substantially impervious to any fluids or incidental moisture (e.g., such as urine or feces, blood, menses, sweat, tears, etc.) or other substances (e.g., such as food, chemical cleaners, ink, oils, greases, etc.). Thus, barrier layer 38 prevents any fluids or other substances from soaking into or otherwise contacting non-coated components of bed unit 10 (such as end panels 12, 14, exteriorly disposed surfaces of side rail members 20, 22, side panels 16, 18, deck 24 and/or any internal support components). As such, bacterial and fungal growth on bed unit 10, as well as any malodors from such deleterious fluids and substances, is substantially eliminated or reduced (as compared to a bed lacking barrier layer 38).

Barrier layer 38 is preferably sufficiently rigid and durable to resist any damage (such as cracks, gouges, scratches, chips, etc.) from ordinary, or even rough or extensive, use of bed unit 10. In addition, barrier layer 38 is preferably resistant to damage or degradation from harsh chemicals, such as bleach or other cleaning solutions. Barrier layer 38 preferably forms a durable and smooth surface within recessed area 36, which may be readily cleaned using such cleaning agents. Such harsh cleaning agents may otherwise be unsuitable for cleaning surfaces formed of wood or wood composite materials. Further, barrier layer 38 is preferably resistant to any damage or attack by fungi or insects.

In a preferred embodiment, barrier layer 38 is formed from a polyurea material. Polyureas are generally formed by reacting amines and isocyanates as crosslinkers or curatives, as known in the art. In one implementation, barrier layer 38 has a thickness of at least about 20 mils (0.02 inch), for example between about 20 mils and about 250 mils (0.25 inch), more preferably between about 20 mils and about 100 mils (0.10 inch), more preferably from about 20 mils and about 40 mils (0.04 inch), and seamlessly covers recessed area 36. Thus, the sleep surface, and area configured for retaining the bedding material and/or mattress, is impervious to fluids, moisture, and other deleterious substances.

The polyurea coating forming barrier layer 38 has been subject to a variety of tests and complies with the Federal Food, Drug and Cosmetic Act and applicable Federal Regulations.

Basic Physical Properties are set forth in Table I below (testing performed by independent third party material test laboratories: OCM Test Laboratories; ISO 17025 Certified; American Association for Laboratory Accreditation (A2LA); Truesdail Laboratories, Inc.; Pira International Materials Test Lab):

TABLE I
Physical Properties:

| Test Name: | Test Methods: | Value: | |
|---|---|---|---|
| Hardness Shore D | ASTM D2240 | 50 ± 1 | |
| Coefficient of Friction | | | |
| Static | ASTM D1894 | 0.546 | |
| Kinetic | | 0.185 | |
| Dielectric Const. | ASTM D150 | 3.5 | |
| Dissipation Factor | ASTM D150 | 0.026 | |
| Volume Resistance | ASTM D257 | 2.4 × 10¹³ | ohm · cm |
| DMA Test | ASTM D4065 | −39° | C. |
| (Loss Modulus, E″ Tg) | | | |
| Elongation | ASTM D412 | 91% | |
| Flexural Strength | ASTM D790 | 1190 | psi |
| Flexural Modulus | ASTM D790 | 0.024 | msi |
| Fungus Resistance | MIL-STD 810F | Pass | |
| Pull-off Test Adhesion | | | |
| to Metal - no primer | | 1300 | psi |
| to Metal - XPM primer | | 1750 | psi |
| to Metal - LX SF-515 primer | | 1930 | psi |
| Taber Abrasion | ASTM D4060 | 0.1525 | |
| (gm Loss/1000 cycles) | | | |
| Tear Strength | ASTM D624 | 295 | lbs/in. |
| Tensile Strength | ASTM D412 | 2147 | psi |
| Water Vapor Trans. | ASTM E96 | 0.796 (grains/hr × sq′) | |
| Methane permeability | ASTM D1434 | 132 | cc/m² · day |

Additional testing included: ANSI/NSF 61-5 (barrier material) coatings for water tanks; USFDA coatings for incidental-food-contact applications; and MIL-STD-810F—fungus resistance.

Additional data results for chemical resistance are presented in Table II below. (Material was immersed in the noted chemicals for a period of seven days; physical properties of pre- and post-immersion were measured to quantify changes in the material).

TABLE II
Chemical Resistances per ASTM D543 for Immersion in Fluids Methods:

| | | | | Tensile | |
|---|---|---|---|---|---|
| | | | Elongation | Strength | |
| | Volume | Hardness | ASTM D412 | ASTM D412 | |
| Chemical Name: | Change (%) | Change (%) | Change (%) | Change (%) | Recommendations |
| Ammonium Chloride 30% | 2% | −11% | NA | NA | YES |
| Ammonium Hydroxide | 3% | −2% | 125% | −45% | YES |
| Automotive Gasoline | 11% | −29% | −46% | −57% | YES |
| Automotive Oil | 0.5% | −11% | −113% | −37% | YES |
| Aviation JP Fuel | 19% | −31% | −29% | −42% | YES |
| Baking Soda 25% | 3% | −17% | 108% | −46% | YES |
| Benzene | −2% | −19% | 108% | −61% | YES |
| Boric Acid 3% | 17% | −2% | 4% | −44% | YES |
| Calcium Chloride 50% | 4% | −27% | 3% | −42% | YES |
| Calcium Hypochloride 5% | 4% | −13% | 0.4% | −48% | YES |
| | | | | | (Secondary Containment) |
| Citric Acid 10% | 5% | −23% | 111% | −46% | YES |
| Club Soda | 0% | −3% | 59% | −0.6% | YES |
| Cream Soda | 4% | −21% | 9% | −45% | YES |
| Crude Oil (Heating) | 12% | −15% | 10% | −48% | YES |
| Diesel Fuel | 8% | −15% | 2% | −42% | YES |
| Ethylene Glycol | 4% | −20% | 3% | −53% | YES |
| Hydraulic Fluid (Oil) | 4% | −20% | 4% | −37% | YES |
| Hydrogen Peroxide 10% | 9% | −22% | 130% | −54% | YES |
| Kerosene | 8% | −17% | 77% | −51% | YES |
| Lactic Acid 20% | 11% | −28% | 101% | −54% | YES |
| Methylene Chloride | 1% | −20% | NA | NA | YES |
| Mineral Spirits | 8% | −16% | −6% | −45% | YES |
| Nitric Acid 10% | 13% | −28% | 122% | −54% | YES |
| | | | | | (Secondary Containment) |
| Potassium Hydroxide 50% | 4% | −17% | 10% | −5% | YES |
| Saline Solution 30% | 3% | −19% | 2.8% | −41% | YES |
| Sea Water | 5% | −20% | 5% | −44% | YES |
| Sodium Carbonate 10% | 2% | −19% | 8% | −38% | YES |
| Sodium Chloride 30% | 4% | −13% | 29% | −38% | YES |
| Sodium Hydroxide 50% | 23% | −15% | 95% | −46% | YES |
| Sodium Hydroxide 10% | −12% | −13% | 102% | −45% | YES |
| Sodium Sulfate 30% | 5% | −21% | 143% | −39% | YES |
| Sodium Sulfate 20% | 5% | −17% | 125% | −44% | YES |
| Sugar Solution 50% | 4% | −20% | 20% | −48% | YES |
| Sulfuric Acid 10% | 8% | −26% | 2% | −40% | YES |
| Toluene | −1% | −21% | 82% | −66% | YES |
| Water | 5% | −20% | −5% | −45% | YES |

The polyurea material is preferably a spray coating material, which is applied onto the desired surfaces of bed unit 10 (e.g., covering recessed area 36) via spray coating methods known in the art. In one implementation, a polyurea spray coating material and methodology similar to that utilized for spray coating truck bed liners is used to form barrier layer 38. Thus, the areas coated with the polyurea material form a substantially smooth and seamless surface in recessed area 36 (including at the interfaces of upper portions 12a, 14a and deck 24, and of side rail members 20, 22 and deck 24).

The barrier layer 38 is preferably applied onto bed unit 10 (or other furniture unit) after all structural components have been assembled. Thus, any gaps or seams between adjoining components are sealed and coated by barrier layer 38. Conventional methods of providing coated or encapsulated boards or components not already fully assembled into a finished product are suitable for some applications. However, a product formed from such encapsulated boards formed from conventional methods includes gaps and seams between the assembled components, and therefore fails to provide a surface sufficiently impervious to fluids and other substances for applications disclosed herein.

Thus, all components of bed unit 10 are preferably first fully assembled prior to application of barrier layer 38. However, the component surfaces of the assembled bed unit 10 need not be finished prior to coating. Rather, barrier layer 38 may be directly applied (e.g., such as via spray-coating) onto unfinished surfaces of the planar surface 34 of deck 24 and/or upper portions 12a, 14a and/or side rail members 20, 22. As such, processing and/or finishing steps, such as sanding, veneering, sealing, painting, etc., for any surfaces to be coated with the barrier layer 38 are eliminated. In addition, adhesion of polyurea material to wood and/or wood composite materials is enhanced when such wood and/or wood composite is raw or unfinished.

The polyurea coating forming barrier layer 38 fills and eliminates any cracks, gouges, or other recesses that may otherwise be present in the upwardly disposed planar surface 34 of deck 24, the inwardly disposed surfaces of upper portions 12a, 14a, and/or the inwardly disposed surfaces of side rail members 20, 22. Thus, an aesthetically appealing surface is provided. In addition, areas within recessed area 36 (which are normally covered by bedding material or a mattress and thus not typically in plain view) in which a person may hide or stow contraband or other items or substances are eliminated.

Preferably, the polyurea coating forming barrier layer 38 is applied to recessed area 36 (and/or other portions of bed unit 10 as desired) so that a seamless edge is formed on the adjacent wood or wood composite (or other material) surfaces to which the polyurea material is applied. The caliper or thickness of the polyurea barrier layer 38 coating the deck 24 and substantially all of the upper portions 12a, 14a and side rail members 20, 22 is preferably at least about 20 mils, preferably between about 20 mils and about 250 mils, more preferably between about 20 mils and about 100 mils, and more preferably between about 20 mils and about 40 mils. However, peripheral edge portions of the barrier layer 38 preferably have a tapered caliper, decreasing to zero or being substantially reduced (e.g., 1/10 or 1/20 or less) as compared to the caliper of the barrier layer 38 coating the deck 24.

Referring to FIG. 3, in some embodiments, barrier layer 38 has a caliper C1 coating the inwardly disposed surface of side rail member 20 (as well as the inwardly disposed surface of side rail member 22, inwardly disposed surfaces of upper portions 12a, 14a, and upwardly disposed surface of deck 24). Barrier layer 38 has a tapered caliper C2 along an interface portion, whereby the caliper of barrier layer 38 is ‘feathered’ or decreases gradually toward the edge or perimeter of barrier layer 38. An edge or periphery of barrier layer 38 has a substantially reduced caliper C3 (e.g, 1/10 or 1/20 or less) as compared to the caliper C1 of barrier layer 38 covering deck 24 (and/or other portions of bed unit 10). In one embodiment, the caliper of barrier layer 38 along peripheral portions of recessed area 36 gradually decreases from a thickness (e.g., caliper C0 of at least about 20 mils (e.g., between about 20 mils and about 40 mils) to a thickness of less than about 2 mils, more preferably less than about 1 mil. In one implementation, the caliper of barrier layer 38 adjacent the outermost or distal edges of side rail members 20, 22 and upper portions 12a, 14a gradually decreases to zero, thus providing for a transitioning region with a tapered caliper decreasing for example over a distance of about 1 inch, more preferably over a distance of about ½-¼ inch, from at least about 20 mils to <1 mil (or to 0 mils).

The resulting seamless and feathered edges of barrier layer 38 are thereby less likely to chip, and additionally “pick-proof” and/or otherwise prevent or minimize the possibility of barrier layer 38 being damaged or mutilated (e.g., even if a user intentionally seeks to damage the coating). In addition, the tapered edges of barrier layer 38 prevent or minimize the possibility of the user from prying a shard or sharp piece of veneer, plywood, etc. from the bed (or other furniture piece), and using such shard to harm themselves or others.

Referring to FIG. 4, in some embodiments, bed unit 10 includes a strip or bead of sealant material 39 (e.g., latex caulk) and/or an additional adhesive and fluid impervious layer disposed adjacent to the interfaces of adjoining components (e.g., a fillet sealant joint). For example, a bead of sealant material 39 may be provided in the inwardly facing corners of interfacing portions of deck 24 and upper portions 12a, 14a, as well as interfacing portions of deck 24 and side rail members 20, 22 within recessed area 36. Barrier layer 38 covers sealant material 39, curving upwardly and providing a gentle slope between outer portions or edges of deck 24 and upper portions 12a, 14a and side rail members 20, 22. Thus, any sharp corners (such as between interfacing portions of the components) are eliminated, thereby reducing the possibility of any fluid or other undesirable substances from becoming entrapped in such corners. The recessed area 36 may thus be more easily cleaned.

It should be understood that the barrier layer 38 of the present invention may be applied to various types of furniture. Therefore, the present invention is not limited to the specific configuration of bed unit 10. For example, beds having other styles or configurations may be provided, which include barrier layer 38. Alternatively, other types of furniture may include barrier layer 38, such as chairs, couches, benches, tables, etc. Moreover, barrier layer 38 may be applied to various areas on bed unit 10 and/or such other types of furniture, as desired for the particular application. For example, it may be desirable for some applications to include a barrier layer 38 on or around the feet, legs and/or other components contacting the support surface (e.g., such as for applications in which the furniture is exposed to water or moisture on the support surface).

In accordance with some embodiments, the barrier layer 38 is applied to portions of the assembled bed unit 10 (or other furniture unit with components already assembled) using a spray device having a spray nozzle. The portion to be coated (e.g., recessed area 36) is spaced from the spray nozzle a first distance when sprayed with the polyurea spray material. The polyurea spray may be applied to a longitudinal swath of the recessed area, extending between opposing ends and covering a portion of the recessed area 36 during a first pass of spray coating. Another longitudinal swath of polyurea spray is applied to the recessed area 36 in a second pass of spray coating, whereby the first and second swaths are adjacent and substantially parallel to each other. Additional passes of spray coating are applied as necessary until the entire recessed area 36 (or other desired area) is coated with a first coat of polyurea material. Preferably, the first coat of polyurea material has a caliper of at least about 20 mils.

During application of the polyurea material forming the first coat, the surface being coated (e.g, recessed area 36 and/or support surface or member) is spaced from the spray nozzle by a first distance, preferably less than about 15 inches from the spray nozzle, more preferably less than about 12 inches. Due to the multiple swaths and passes of spray coating, and given the relatively thick layer of polyurea material desired for the first coat (e.g., 20 mils or more), the first coat of polyurea material typically includes raised seam lines between the adjacent swaths and/or an uneven or rough surface. Therefore, a secondary or finish coat of polyurea material is applied to the recessed area 36.

During application of the polyurea material forming the second coat, the surface being coated (e.g., the recessed area 36 covered with the first coat of polyurea) is spaced from the spray nozzle by a second distance that is preferably at least twice the first distance, for example preferably at least about 20 inches from the spray nozzle, more preferably at least about 24 inches, for example, between about 24-36 inches. In addition, the second coat of polyurea material preferably has a caliper of about 2 mils or less, more preferably less than about 1 mil. Thus, the second coat provides a relatively light spray of polyurea mist, resulting in a light coat of polyurea material that substantially eliminates any seam lines and/or uneven or rough surfaces. (In contrast, many conventional applications using polyurea coatings seek to provide a rough and uneven surface in order to increase frictional or adhesive properties). The resulting barrier layer 38 has an extremely smooth surface, thus minimizes the possibility of any fluids or other undesirable substances from being trapped or caught thereon. In addition, the smooth surface of barrier layer 38 is easy to clean, and aesthetically pleasing to users.

While the present invention has been described in connection with particular embodiments, it will be understood that it is capable of further modifications and this application is intended to cover any such variations, uses, or adaptations of the invention following, in general, the principles of the invention and including such departures from the present disclosure as come within known or customary practice within the art to which the invention pertains and as may be applied to the features hereinbefore set forth. Moreover, features of one embodiment may be provided in conjunction with features from other embodiments.

What is claimed is:

1. A furniture unit, comprising
a support member having a central portion, an edge portion surrounding said central portion, and an interface portion intermediate and interconnecting said central portion and said edge portion; and
a barrier layer impervious to fluid and coating said central portion and said interface portion, said barrier layer having a first caliper of at least about 20 mils coating said central portion, and a second caliper tapered from at least about 20 mils adjacent said first caliper to less than about 1 mil adjacent said edge portion.

2. The furniture unit of claim 1, wherein said barrier layer comprises a polyurea material.

3. The furniture unit of claim 1, wherein said support member is formed from a material selected from the group consisting of solid wood, wood composite, and engineered wood.

4. The furniture unit of claim 1, wherein said first caliper is between about 20 mils and about 250 mils.

5. The furniture unit of claim 1, wherein said barrier layer has a Shore Hardness D value of at least about 50.

6. The furniture unit of claim 1, wherein said barrier layer has a flexural strength value of at least about 1000 psi.

7. The furniture unit of claim 1, wherein said barrier layer is impervious to fungus and insects.

8. A furniture unit, comprising:
a planar support panel having a generally rectangular configuration including a central portion, and opposing side portions and opposing end portions surrounding said central portion;
opposing side panels connected to and extending upwardly from said opposing side portions, respectively;
opposing end panels connected to and extending upwardly from said opposing end portions, respectively, wherein said planar support panel, and said opposing side and end panels define a recessed area; and
a barrier layer impervious to fluid and coating said recessed area, said barrier layer having a first caliper adjacent said central portion and a second caliper adjacent distal edges of said opposing side and end panels, said first caliper at least 10 times greater than said second caliper.

9. The furniture unit of claim 8, wherein said first caliper is at least about 20 mils.

10. The furniture unit of claim 8, wherein said second caliper is less than about 1 mil.

11. The furniture unit of claim 8, wherein said barrier layer has a tapered third caliper from said first caliper to said second caliper.

12. The furniture unit of claim 8, wherein said furniture unit is a bed, and said recessed area is configured to receive bedding material.

13. The furniture unit of claim 8, wherein said barrier layer comprises a polyurea material.

14. The furniture unit of claim 8, wherein said planar support panel and said opposing side and end panels are formed from a material selected from the group consisting of solid wood, wood composite, and engineered wood.

15. The furniture unit of claim 8, further comprising a sealant bead disposed along and covering interfaces between said opposing side panels and said opposing side portions, and covering interfaces between said opposing end panels and said opposing end portions, said barrier layer covering said sealant bead.

16. A method of manufacturing a furniture unit having a support member impervious to fluids, comprising the steps of:
providing an assembled furniture unit comprising a planar support portion;
applying via a spray device having a spray nozzle at least first and second swaths of polyurea material onto said planar support portion, said first and second swaths forming a first coat of polyurea material having a caliper of at least about 20 mils and a raised seam intermediate said first and second swaths, wherein said planar support portion is spaced a first distance from said spray nozzle when applying said first and second swaths; and
applying via said spray device at least a third swath of polyurea material onto said first and second swaths and covering said raised seam, said third swath forming a second coat of polyurea material having a caliper of about 2 mils or less, wherein said planar support portion is spaced a second distance from said spray nozzle when applying said third swath, said second distance at least about twice said first distance.

17. The method of claim 16, wherein said first distance is about 15 inches or less.

18. The method of claim 16, wherein said second distance is at least about 20 inches.

19. The method of claim 16, wherein said second coat has a caliper of less than about 1 mil.

20. The method of claim 16, wherein said planar support portion is formed from a material selected from the group consisting of solid wood, wood composite, and engineered wood.
